(19) United States
(12) Patent Application Publication
(10) Pub. No.: US 2026/0287883 A1
(43) Pub. Date: Sep. 24, 2026

(54) APPARATUS FOR APPLYING VOLTAGE TO LIQUID AND METHOD FOR MANUFACTURING SAME

(71) Applicant: SHARP KABUSHIKI KAISHA, Sakai City (JP)

(72) Inventors: Takeshi Hara, Sakai City (JP); Hiroaki Furukawa, Sakai City (JP); Eiji Fujimoto, Sakai City (JP); Masaki Fujiwara, Sakai City (JP); Tetsuo Fujita, Sakai City (JP); Akihiro Oda, Sakai City (JP)

(21) Appl. No.: 19/563,189

(22) Filed: Mar. 11, 2026

(30) Foreign Application Priority Data
Mar. 24, 2025 (JP) 2025-048787

(51) Int. Cl. G02B 26/00

(52) U.S. Cl. CPC G02B 26/005; G02B 2207/115

(57) ABSTRACT

An apparatus for applying a voltage to a liquid includes a first substrate including a plurality of first electrodes formed from a noble metal and a second substrate including a second electrode facing the plurality of first electrodes. A gap filled with or able to be filled with the liquid is maintained between the first substrate and the second substrate.

### BACKGROUND

### 1. Field

The present disclosure relates to an apparatus for applying a voltage to a liquid and a method for manufacturing the same.

### 2. Description of the Related Art

Various apparatuses that utilize electrowetting have been developed. Japanese Unexamined Patent Application Publication (Translation of PCT Application) No. 2016-535866 discloses an electrowetting display.

However, an apparatus for applying a voltage to a liquid, such as an apparatus for measuring the potential of a liquid, an apparatus for conducting electrophoresis, and an apparatus that utilizes an electric reaction of a liquid, as well as an electrowetting apparatus, is prone to corrosion by a liquid of a first electrode for applying a voltage to the liquid. Such corrosion causes decreases in durability and reliability of the apparatus.

An EWOD (electrowetting on dielectric) type of electrowetting apparatus has been developed in which a first electrode is coated with a dielectric. However, a crack in a dielectric layer makes the first electrode prone to corrosion by a liquid. Further, in the apparatus for measuring the potential of a liquid and the apparatus that utilizes an electric reaction of a liquid, it is preferable that a first electrode come into direct contact with the liquid.

It is desirable to improve the durability and reliability of an apparatus for applying a voltage to a liquid.

### SUMMARY

According to an aspect of the disclosure, there is provided an apparatus for applying a voltage to a liquid. The apparatus includes a first substrate including a support, a plurality of first electrodes formed from a noble metal, and a first organic insulating film located between the support and the plurality of first electrodes and a second substrate including a second electrode facing the plurality of first electrodes. A gap filled with or able to be filled with the liquid is maintained between the first substrate and the second substrate.

According to an aspect of the disclosure, there is provided a method for manufacturing an apparatus for applying a voltage to a liquid. The method includes forming a photoresist layer on top of the first organic insulating film, patterning the photoresist layer so that an end portion of the photoresist layer has an inverse tapered shape, forming a noble metal layer on top of the photoresist layer thus patterned and on top of a portion of the first organic insulating layer exposed from the photoresist layer, and forming the plurality of first electrodes from the noble metal layer by removing the photoresist layer together with a portion of the noble metal layer formed on top of the photoresist layer.

### BRIEF DESCRIPTION OF THE DRAWINGS

FIG. 1 is a partial cross-sectional view showing an example configuration of an electrowetting apparatus according to an embodiment of the present disclosure;

FIG. 2 is a flow chart showing an example of a method for manufacturing the electrowetting apparatus shown in FIG. 1;

FIG. 3 is a partial cross-sectional view showing examples of steps of manufacturing a plurality of first electrodes of the electrowetting apparatus shown in FIG. 1;

FIG. 4 is a partial cross-sectional view showing an example configuration of an electrowetting apparatus according to an embodiment of the present disclosure;

FIG. 5 is a partially enlarged cross-sectional view showing an example configuration of an end portion of a first electrode shown in FIG. 4 and an area therearound;

FIG. 6 is a flow chart showing an example of a method for manufacturing the electrowetting apparatus shown in FIG. 4;

FIG. 7 is a partial cross-sectional view showing an example configuration of an electrowetting apparatus according to an embodiment of the present disclosure;

FIG. 8 is a partially enlarged cross-sectional view showing an example configuration of an end portion of a first electrode shown in FIG. 7 and an area therearound;

FIG. 9 is a flow chart showing an example of a method for manufacturing the electrowetting apparatus shown in FIG. 7; and

FIG. 10 is a partial cross-sectional view showing an example configuration of an electrowetting apparatus according to an embodiment of the present disclosure.

### DESCRIPTION OF THE EMBODIMENTS

For simplicity of explanation, the following illustrates an electrowetting apparatus that utilizes electrowetting. However, the scope of the present disclosure encompasses not only the electrowetting apparatus but also an apparatus for applying a voltage to a liquid, such as an apparatus for measuring the potential of a liquid, an apparatus for conducting electrophoresis, and an apparatus that utilizes an electric reaction of a liquid.

### EMBODIMENT 1

The following describes an embodiment of the present disclosure.

### Configuration

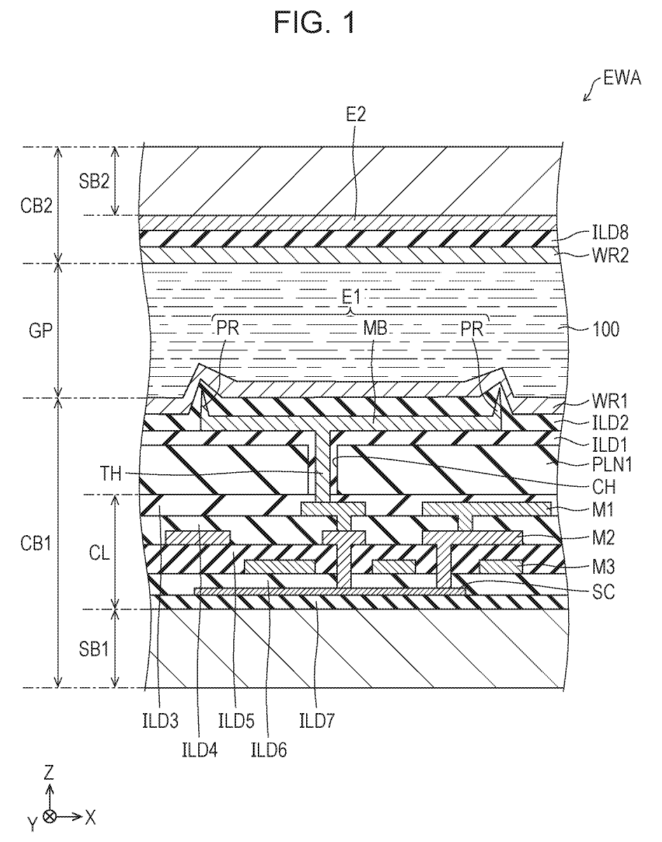

FIG. 1 is a partial cross-sectional view showing an example configuration of an electrowetting apparatus EWA according to an embodiment of the present disclosure. As shown in FIG. 1, the electrowetting apparatus EWA according to the present disclosure is an apparatus for applying a voltage to a liquid 100. The electrowetting apparatus EWA includes a first substrate CB1 and a second substrate CB2. In the electrowetting apparatus EWA, a gap GP filled with or able to be filled with the liquid 100 is maintained between the first substrate CB1 and the second substrate CB2. The first substrate CB1 includes a first support SB1, a plurality of first electrodes E1 formed from a noble metal, and a first organic insulating film PLN1 located between the support SB1 and the plurality of first electrodes E1. The second substrate CB2 includes a second electrode E2 facing the plurality of first electrodes E1.

The electrowetting apparatus EWA selects one or more first electrodes E1 from among the plurality of first electrodes E1 and applies a voltage between the first electrodes E1 thus selected and the second electrode E2. As a result of this, the voltage is applied to portions of the liquid 100 that correspond to the first electrodes E1 thus selected.

It is difficult to process the noble metal into a desired shape, as the noble metal is not able to be subjected to wet etching or dry etching. For this reason, a base metal has been used in forming a plurality of electrodes on an identical surface, and a plurality of first electrodes of a conventional electrowetting apparatus have been formed from a base metal.

The liquid 100 is a liquid selected from the group consisting of an ionic liquid, a polar liquid such as water and alcohol, and an electrolytic solution. The ionic liquid is a melt of a salt having a melting point of 100°C or lower, preferably an ambient temperature molten salt. For this reason, the liquid 100 easily corrodes a base metal. Examples of base metals that form passive layers in reaction to the liquid 100 include titanium (Ti), niobium (Nb), tungsten (W), chromium (Cr), and nickel (Ni), and examples of base metals that react with the liquid 100 but do not form passive layers include aluminum (Al), molybdenum (Mo), and copper (Cu). When a first electrode formed from a base metal that turns into a passive state comes into contact with the liquid 100 and applies a voltage to the liquid 100, the thickness of the passive layer increases and the thickness of a metallic portion of the first electrode decreases. The passive layer is lower in electric conductivity than the original metal. Therefore, even when a first electrode E1 for applying a voltage to the liquid 100 is formed from a base metal that turns into a passive state, the first electrode E1 is easily corroded by the liquid 100, with the result that the durability and reliability of the conventional electrowetting apparatus have been negatively affected.

On the other hand, it is hard for the noble metal to be corroded by the liquid 100; however, as mentioned earlier, it is difficult to process the noble metal. Therefore, the noble metal has conventionally been ruled out as a candidate material that can be used to from the plurality of first electrodes of the electrowetting apparatus.

According to the foregoing configuration of the present disclosure, the electrowetting apparatus EWA has a first substrate CB1 having a plurality of first electrodes E1 formed from a noble metal. It is hard for the noble metal to be corroded by the liquid 100. This makes it possible to improve the durability and reliability of the electrowetting apparatus EWA.

The terms "noble metal" and "noble metal element" used herein encompass gold (Au), silver (Ag), platinum (Pt), palladium (Pd), iridium (Ir), and rhodium (Rh). The term "noble metal" used herein further encompasses an alloy composed of two or more metals selected from the group consisting of gold, silver, palladium, iridium, and rhodium. When the noble metal element occupies a molar ratio of 10% or more, preferably 50% or more, more preferably 80% or more, of the composition of a constituent element, the constituent element is formed from a noble metal. The term "base metal" used herein means a metal that is not a noble metal, and the term "base metal element" used herein means a metal element that is not a noble metal element.

Terms such as "above", "upper", and "upward" used herein mean a side of the first substrate CB1 at which the second substrate CB2 is located, and it is assumed that this direction is a Z-axis positive direction. Terms such as "below", "lower", and "downward" used herein mean a side of the second substrate CB2 at which the first substrate CB1 is located, and it is assumed that this direction is a Z-axis negative direction. Terms such as "lateral" used herein mean directions orthogonal to the Z axis, and it is assumed that one of the directions orthogonal to the Z axis is an X-axis direction and that a direction orthogonal to both the Z axis and the X axis is a Y-axis direction.

The term "cross-sectional view" used herein means a view from a direction orthogonal to the Z axis, and the term "plan view" used herein means a view from a Z-axis direction. Terms such as "thickness", "height", and "depth" used herein mean sizes in a Z-axis direction.

The first substrate CB1 may include a first inorganic insulating film ILD1 located between the first organic insulating film PLN1 and the plurality of first electrodes E1. The first inorganic insulating film ILD1 covers the first organic insulating film PLN1 and can thereby inhibit the liquid 100 from penetrating into the first organic insulating film PLN1. This results in making it hard for the first organic insulating film PLN1 to swell, and makes it hard for the liquid 100 to penetrate toward the support SB1 (on the lower side of FIG. 1) beyond the first organic insulating film PLN1. This makes it possible to improve the durability and reliability of the electrowetting apparatus EWA.

The first substrate CB1 may include a liquid-repellent layer WR1, located opposite the support SB1 behind the plurality of first electrodes E1, that repels the liquid 100 and a second inorganic insulating film ILD2 located between the plurality of first electrodes E1 and the liquid-repellent layer WR1. The liquid-repellent layer WR1 and the second inorganic insulating film ILD2 cover the plurality of first electrodes E1 and can thereby inhibit the liquid 100 from coming into contact with any one or more of the plurality of first electrodes E1. The liquid-repellent layer WR1 and the second inorganic insulating film ILD2 cover the first organic insulating film PLN1 and can thereby inhibit the liquid 100 from penetrating into the first organic insulating film PLN1. The liquid-repellent layer WR1 and the second inorganic insulating film ILD2 extend along lower surfaces of the first electrodes E1 and side surfaces of through conductors TH and can thereby inhibit the liquid 100 from penetrating toward the support SB1 (on the lower side of FIG. 1) beyond the first organic insulating film PLN1. This makes it possible to further improve the durability and reliability of the electrowetting apparatus EWA.

The liquid-repellent layer WR1 and the second inorganic insulating film ILD2 may be dielectrics. The electrowetting apparatus EWA may be an EWOD (electrowetting on dielectric) apparatus in which the plurality of first electrodes E1 are coated with the dielectrics. Even if the liquid-repellent layer WR1 and the second inorganic insulating film ILD2 crack and the liquid 100 comes into contact with a first electrode E1, it is hard for the liquid 100 to corrode the plurality of first electrodes E1, as the plurality of first electrodes E1 are formed from the noble metal.

The first substrate CB1 may further include one or more wires M3, located between the support SB1 and the first organic insulating film PLN1, that contain a metal that is corroded by the liquid 100. When the first substrate CB1 includes a plurality of wires M1, M2, and M3, for example, all of the wires M1, M2, and M3 may contain the metal that is corroded by the liquid 100. Further, for example, the wires M2 and M3 other than the wire M1, which is closest to the first organic insulating film PLN1, may contain the metal that is corroded by the liquid 100. Further, for example, only the wires M3, which are closest to the support SB1, may contain the metal that is corroded by the liquid 100.

The metal that is corroded by the liquid 100 is one or more metals selected from the group consisting of base metals that form passive layers in reaction to the liquid 100 and base metals that react with the liquid 100 but do not form passive layers. The wires M3, which contain the metal that is corroded by the liquid 100, may have a three-layer structure (Ti/Al/Ti) in which a layer composed of aluminum is sandwiched between two layers composed of titanium.

If the first organic insulating film PLN1 is damaged, the liquid 100 reaches a wire M3, which contains the metal that is corroded by the liquid 100, and the wire M3 is corroded by the liquid 100. Therefore, the plurality of first electrodes E1 are formed with the first organic insulating film PLN1 kept maintained. The metal that is corroded by the liquid 100 can be subjected to wet etching and/or dry etching and is easily processed into a desired shape. Therefore, it is easy to form a wire that contains the metal that is corroded by the liquid 100.

The first substrate CB1 may include a circuit layer CL located between the support SB1 and the first organic insulating film PLN1. The circuit layer CL may include one or more wires M1, M2, and M3 and may include one or more semiconductor layers SC. Each of the semiconductor layers SC may contain low-temperature polysilicon, (LTPS), amorphous silicon, and an oxide semiconductor such as indium germanium tin oxide (InGaZnO). Each of the semiconductor layers SC may contain a p-type semiconductor or may contain an n-type semiconductor. The circuit layer CL may include both a p-type semiconductor layer and an n-type semiconductor layer. The circuit layer CL may include one or more inorganic insulating films ILD3, ILD4, ILD5, ILD6, and ILD7.

Each of the first electrodes E1 may have a body portion MB formed along the first organic insulating film PLN1 and a projecting portion PR, formed on top of an end portion of the body portion MB, that projects from the body portion MB in a direction away from the first organic insulating film PLN1. The first electrode E1 may be connected to any one or more of the wires M1, M2, and M3 included in the circuit layer CL via a through conductor TH bored through the first organic insulating film PLN and located within a contact hole CH.

The second substrate CB2 may include a liquid-repellent layer WR2, located opposite the support SB2 behind the second electrode E2, that repels the liquid 100 and an inorganic insulating film ILD8 located between the second electrode E2 and the liquid-repellent layer WR2. The liquid-repellent layer WR2 and the inorganic insulating film ILD8 cover the second electrode E2 and can thereby inhibit the liquid 100 from coming into contact with second electrode E2.

### Manufacturing Method

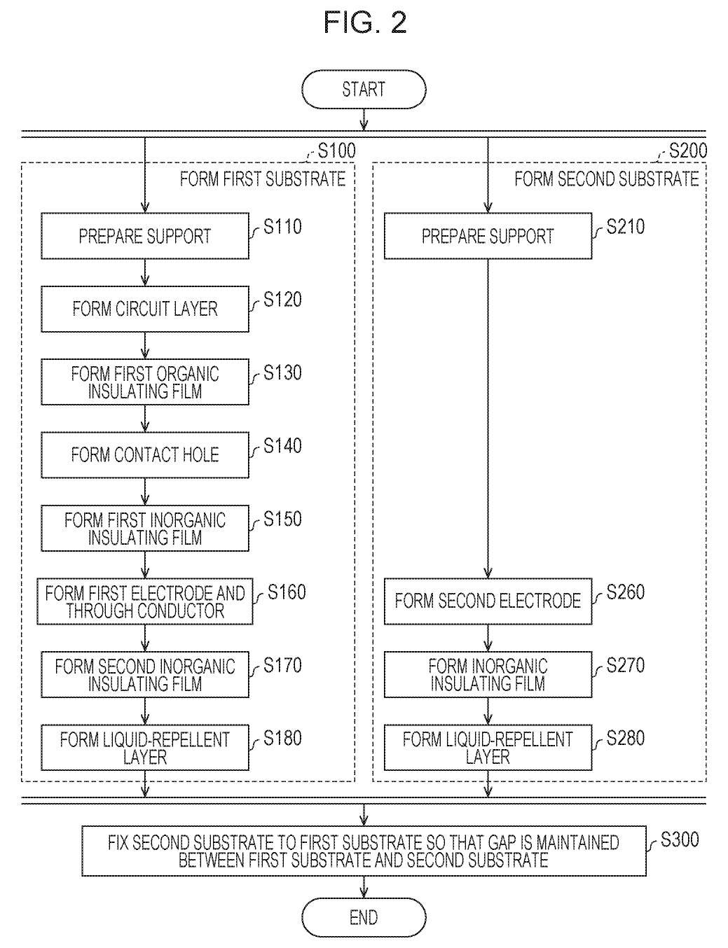

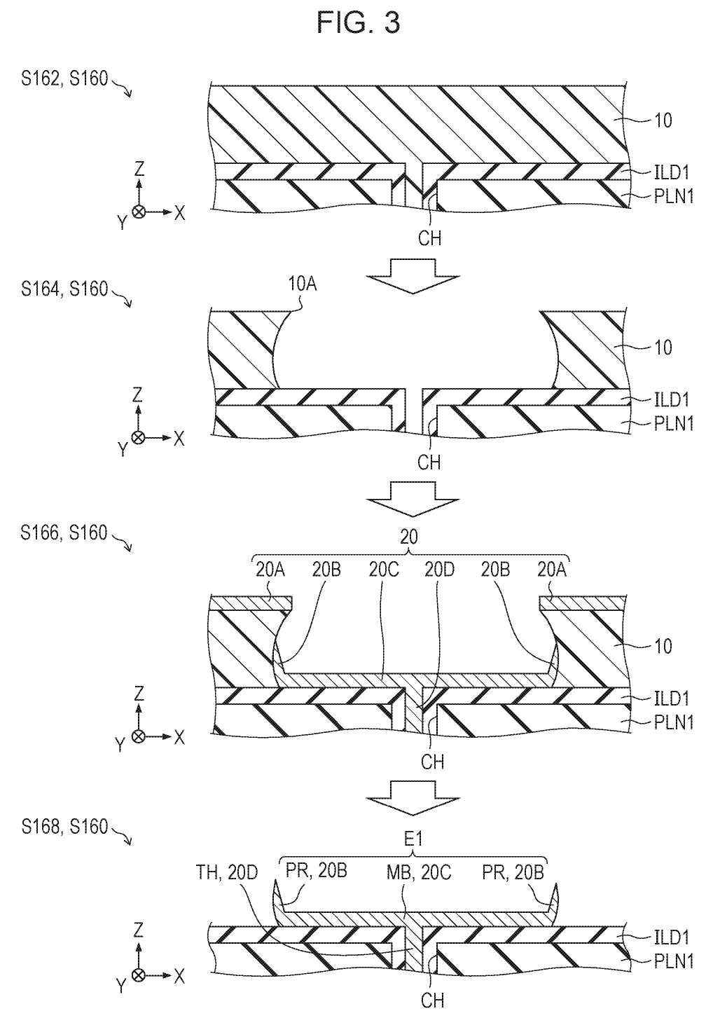

FIG. 2 is a flow chart showing an example of a method for manufacturing the electrowetting apparatus EWA shown in FIG. 1. FIG. 3 is a partial cross-sectional view showing examples of steps of manufacturing a plurality of first electrodes E1 of the electrowetting apparatus EWA shown in FIG. 1.

As shown in FIG. 2, the support SB1 of the first substrate CB1 is prepared (step S110), and the circuit layer CL is formed on top of the support SB1 (step S120).

The first organic insulating film PLN1 is formed on top of the circuit layer CL (step S130), and the contact hole CH is formed in the first organic insulating film PLN1 (step S140). The first organic insulating film PLN1 may be formed by applying and solidifying a liquid containing organic resin such as acrylic resin and polyimide resin onto the circuit layer CL. It is preferable that the first organic insulating film PLN1 be formed from photosensitive resin, i.e. a photoresist, so that the contact hole can be formed using a photolithographic technique.

Then, the first inorganic insulating film ILD1 is formed on top of the first organic insulating film PLN1 (step S150). The first inorganic insulating film ILD1 may be a single layer containing silicon oxide (SiOₓ), silicon nitride (SiN_{y}), or silicon oxynitride (SiOₓN_{y}) or may be a multilayer in which silicon oxide and silicon nitride are alternately stacked. The plurality of first electrodes E1 are formed on top of the first inorganic insulating film ILD1, and through conductors TH are formed separately in each of a plurality of the contact holes CH of the first organic insulating film PLN1 (step S160).

As shown in FIG. 3, in step S160, a photoresist layer 10 is solidly formed on top of the first inorganic insulating film ILD1 covering the first organic insulating film PLN1 (step S162). For example, the photoresist layer 10 is formed by applying and solidifying a liquid containing a photoresist onto the first inorganic insulating film ILD1. The photoresist layer 10 is a layer for a lift-off process. For simplicity of explanation, the first inorganic insulating film ILD1 is ignored in the subsequent description of step S160.

Next, the photoresist layer 10 is patterned using the photolithographic technique so that an end portion of the photoresist layer 10 has an inverse tapered shape (step S164). In other words, the photoresist layer 10 is patterned so that an edge 10A of an upper surface of the photoresist layer 10 projects into the air or so that the angle between the upper surface of the photoresist layer 10 and an end face of the photoresist layer 10 is smaller than 90 degrees. The patterning causes part of the first organic insulating film PLN1 to be exposed from the photoresist layer 10.

Next, a noble metal layer 20 is solidly formed on top of the photoresist layer 10 thus patterned and on top of a portion of the first organic insulating film PLN1 exposed from the photoresist layer 10 (step S166). The noble metal layer 20 may be formed using a sputtering apparatus or a plating apparatus. The noble metal layer 20 includes a first portion 20A formed on top of the upper surface of the photoresist layer 10, a second portion 20B formed along the end face of the photoresist layer 10, a third portion 20C formed on top of the exposed portion of the first organic insulating film PLN1, and a fourth portion 20D formed in the contact hole CH bored through the first organic insulating film PLN1. Since the end portion of the photoresist layer 10 has an inverse tapered shape, the first portion 20A is separate from the second portion 20B. Meanwhile, the third portion 20C is contiguous to both the second portion 20B and the fourth portion 20D.

Then, the plurality of first electrodes E1 and the plurality of through conductors TH are formed from the noble metal layer 20 by removing the photoresist layer 10 together with the first portion 20A of the noble metal layer 20 formed on top of the photoresist layer 10 (step S168). Since the first portion 20A is separate from the second portion 20B, the first portion 20A can be removed with the second portion 20B, the third portion 20C, and the fourth portion 20D left. The second portion 20B of the noble metal layer 20 becomes the projecting portion PR of a first electrode E1. The third portion 20C of the noble metal layer 20 becomes the body portion MB of the first electrode E1. The fourth portion 20D of the noble metal layer 20 becomes a through conductor TH.

As shown in FIG. 2, after step S160, the second inorganic insulating film ILD2 was formed on top of the plurality of first electrodes E1 (step S170). The second inorganic insulating film ILD2 may be a single layer containing silicon oxide (SiOₓ), silicon nitride (SiN_{y}), or silicon oxynitride (SiOₓN_{y}) or may be a multilayer in which silicon oxide and silicon nitride are alternately stacked. The second inorganic insulating film ILD2 may be formed by depositing any one or more of silicon nitride, silicon oxide, and silicon oxynitride so that the second inorganic insulating film ILD2 has a total thickness greater than or equal to 100 nm and less than or equal to 400 nm.

The liquid-repellent layer WR1 is formed on top of the second inorganic insulating film ILD2 (step S180). The liquid-repellent layer WR1 may be formed by applying and drying a water-repellent surface preparation agent such as a fluorine-based coating agent onto the second inorganic insulating film ILD2. The method of application may be any method such as a dip coating method, a slit coating method, and a printing method. The liquid-repellent layer WR1 may have a thickness greater than or equal to 30 nm and less than or equal to 100 nm. As a result of these steps, the first substrate CB1 is formed (step S100).

Further, the support SB2 of the second substrate CB2 is prepared (step S210). The second electrode E2 is formed on top of the support SB2 (step S260). The inorganic insulating film ILD8 is formed on top of the second electrode E2 (step S270). The liquid-repellent layer WR2 is formed on top of the inorganic insulating film ILD8 (step S280). As a result of this, the second substrate CB2 is formed (step S200).

The first substrate CB1 has a mounting terminal, and the second inorganic insulating film ILD2 and the liquid-repellent layer WR1 of the first substrate CB1 are each patterned so that the mounting terminal is exposed. This patterning may involve the use of a photolithographic technique and dry etching or the use of a lift-off method. The second substrate CB2 has a mounting terminal, and the inorganic insulating film ILD8 and the liquid-repellent layer WR2 of the second substrate CB2 are each patterned so that the mounting terminal is exposed.

After completion of both the first substrate CB1 and the second substrate CB2, the first substrate CB1 is fixed to the second substrate CB2 so that the gap GP is maintained between the first substrate CB1 and the second substrate CB2 (step S300). The first electrodes E1 and the second electrode E2 are located between the supports SB1 and SB2 of the first substrate CB1 and the second substrate CB2, and the gap GP is located between the first electrodes E1 and the second electrode E2. The gap GP may be maintained by placing a spacer between the first substrate CB1 and the second substrate CB2.

### Example

Manufacture of a first substrate CB1 according to an example of Embodiment 1 is described below with reference to FIGS. 1 to 3.

A glass substrate was prepared as the support SB1 of the first substrate CB1 (step S110), and a basecoat film was formed by depositing a silicon oxide film having a thickness of 100 nm and a silicon nitride film having a thickness of 100 nm in this order on top of the glass substrate with a chemical vapor deposition (CVD) apparatus. The basecoat film corresponds to the inorganic insulating film ILD7 of FIG. 1. The semiconductor layer SC was formed by depositing an LTPS having a thickness of 40 nm on top of the basecoat film and patterning the LTPS by performing a dehydrogenation annealing process and a laser annealing process on the LTPS. A gate insulating film was formed by depositing a silicon oxide film having a thickness of 100 nm on top of the semiconductor layer SC with the CVD apparatus. The gate insulating film corresponds to the inorganic insulating film ILD6 of FIG. 1. A gate electrode was formed by depositing a molybdenum-tungsten (MoW) alloy film having a thickness of 300 nm on top of the gate insulating film and patterning the MoW alloy film. The gate electrode corresponds to a wire M3 of FIG. 1.

Then, the semiconductor layer SC was subjected to a low-concentration doping process and a high-concentration doping process through the gate insulating film and the gate electrode. After the doping, a first interlayer insulating film was formed by depositing a silicon oxide film having a thickness of 700 nm and a silicon nitride film having a thickness of 200 nm on top of the gate electrode with the CVD apparatus. The first interlayer insulating film corresponds to the inorganic insulating film ILD5 of FIG. 1. A source electrode was formed by forming a connecting contact hole in the first interlayer insulating film, depositing a titanium film having a thickness of 30 nm, an aluminum film having a thickness of 300 nm, and a titanium film having a thickness of 20 nm in this order on top of the first interlayer insulating film with the sputtering apparatus, and patterning the titanium/aluminum/titanium layered product. The source electrode corresponds to the wire M2 of FIG. 1.

Then, a second interlayer insulating film was formed by depositing a silicon nitride film having a thickness of 300 nm on top of the source electrode with the CVD apparatus. The second interlayer insulating film corresponds to the inorganic insulating film ILD4 of FIG. 1. An electrode was formed by forming a connecting contact hole in the second interlayer insulating film, depositing a titanium film having a thickness of 100 nm, an aluminum film having a thickness of 600 nm, and a titanium film having a thickness of 20 nm in this order on top of the second interlayer insulating film with the sputtering apparatus, and patterning the Ti/Al/Ti layered product. The electrode corresponds to the wire M1 of FIG. 1.

Then, a third interlayer insulating film was formed by depositing a silicon oxide film having a thickness of 400 nm and a silicon nitride film having a thickness of 150 nm on top of the electrode with the CVD apparatus. The third interlayer insulating film corresponds to the inorganic insulating film ILD3 of FIG. 1. A planarizing film was formed by applying and solidifying a liquid containing a photoresist onto the third interlayer insulating film. The planarizing film corresponds to the first organic insulating film PLN1 of FIG. 1. A contact hole CH bored through the planarizing film was formed by patterning the planarizing layer with a 2-μm photolithographic technique. Steps hitherto described correspond to steps S110 to S140 of FIG. 2.

Then, the first inorganic insulating film ILD1 was formed by depositing a silicon oxide film having a thickness of 100 nm on top of the first organic insulating film PLN1 with the CVD apparatus (step S150). Then, a connecting contact hole passed through the contact hole CH and bored through the third interlayer insulating film and the first inorganic insulating film ILD1 was formed by etching the third interlayer insulating film and the first inorganic insulating film ILD1 at the same time. Then, as described above with reference to FIG. 3, the plurality of first electrodes E1 were formed by forming and patterning the photoresist layer 10 on top pf the first inorganic insulating film ILD1 and forming and patterning the noble metal layer 20 (step S160). As the noble metal layer 20, a platinum film having a thickness of 500 nm and a titanium film having a thickness of 100 nm were deposited by the sputtering apparatus.

The second inorganic insulating film ILD2 was formed on top of the plurality of first electrodes E1 (step S170). Then, the second inorganic insulating film ILD2 was patterned using the photolithographic technique and dry etching so that a portion of the second inorganic insulating film ILD2 on top of the mounting terminal was removed. The liquid-repellent layer WR1 was formed by applying and drying a surface treatment agent forming a fluorine-based water-repellent film on top of the second inorganic insulating film ILD2. Then, the second inorganic insulating film ILD2 was patterned using the photolithographic technique and dry etching so that a portion of the second inorganic insulating film ILD2 on top of the mounting terminal was removed.

### EMBODIMENT 2

Another embodiment of the present disclosure is described below. For convenience of explanation, members having the same functions as those described in the foregoing embodiment are given the same reference signs, and a description of such members is not repeated.

### Configuration

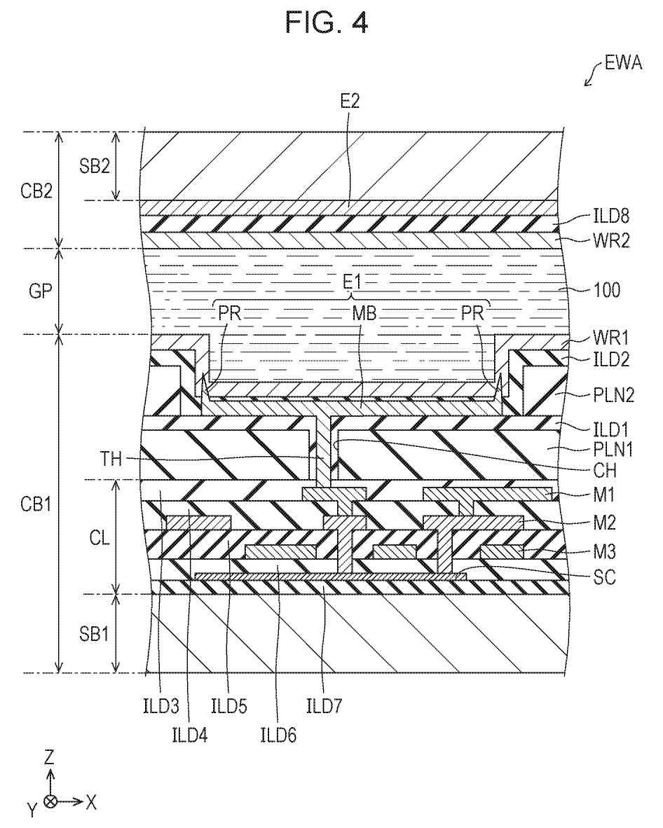

FIG. 4 is a partial cross-sectional view showing an example configuration of an electrowetting apparatus EWA according to an embodiment of the present disclosure. As shown in FIG. 4, the first substrate CB1 of the electrowetting apparatus EWA according to the present disclosure may include a second organic insulating film PLN2 located lateral to at least one of the plurality of first electrodes E1 in a cross-sectional view. The second organic insulating film PLN2 makes it hard for the corresponding first electrode E1 to be touched or collided with by another object (e.g. a hand or an instrument during assembly) and reduces damage of the corresponding first electrode E1 by contact or collision.

It is preferable that the second organic insulating film PLN2 surround the corresponding first electrode E1 in a plan view. By surrounding the corresponding first electrode E1, the second organic insulating film PLN2 can make it hard for the corresponding first electrode E1 to be touched or collided with from any direction orthogonal to the Z axis. It is preferable that the distance between the second organic insulating film PLN2 and the corresponding first electrode E1 be small, e.g. equal to or smaller than 10 μm in a plan view.

It is preferable that the second organic insulating film PLN2 be sufficiently great in thickness. Specifically, it is preferable that for each first electrode E1 corresponding to the second organic insulating film PLN2, the whole of the first electrode E1 be located between an upper surface of the first organic insulating film PLN1 and an upper surface of the second organic insulating film PLN2 in a Z-axis direction. By being sufficiently great in thickness, the second organic insulating film PLN2 can make it hard for the corresponding first electrode E1 to be touched or collided with at any level in a Z-axis direction. The "upper surface" is a surface of the first substate CB1 that faces away from the support SB1.

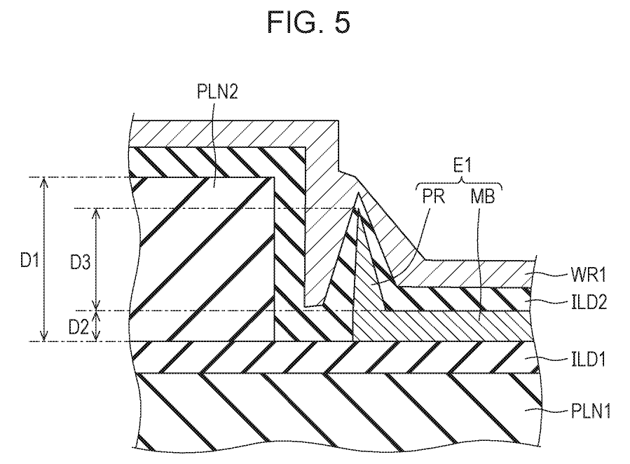

FIG. 5 is a partially enlarged cross-sectional view showing an example configuration of an end portion of a first electrode E1 shown in FIG. 4 and an area therearound. When, as shown in FIG. 5, the first electrode E1 has a body portion MB formed along the first organic insulating film PLN1 and a projecting portion PR, formed on top of an end portion of the body portion MB, that projects from the body portion MB in a direction away from the first organic insulating film PLN1, it is preferable that the thickness D1 of the second organic insulating film PLN2 be greater than or equal to the sum of the thickness D2 of the body portion MB of the corresponding first electrode E1 and the height D3 of the projecting portion PR.

### Manufacturing Method

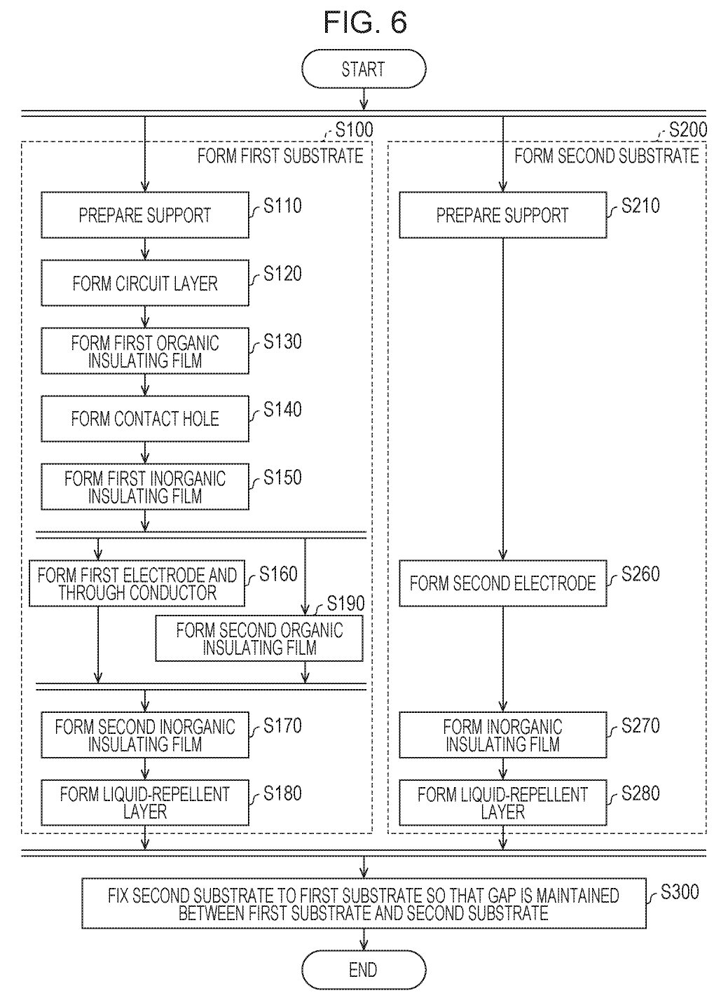

FIG. 6 is a flow chart showing an example of a method for manufacturing the electrowetting apparatus EWA shown in FIG. 4. As shown in FIG. 6, in the formation of the first substrate CB1 (step S100), the second organic insulating film PLN2 is formed (step S190) between the formation of the first inorganic insulating film ILD1 (step S150) and the formation of the second inorganic insulating film ILD2 (step S170). Step S190 may precede or follow the formation of the first electrodes E1 and the through conductors TH (step S160). It is beneficial to execute step S190 after step S160 to avoid the risk of the second organic insulating film PLN2 being damaged by step S160.

In step S190, for example, the second organic insulating film PLN2 may be formed by forming an organic resin layer on top of the first inorganic insulating film ILD1 and patterning the organic resin layer. The organic resin layer may be formed by applying and solidifying a liquid containing organic resin such as acrylic resin and polyimide resin onto the first inorganic insulating film ILD1. It is preferable that the organic resin layer be formed from photosensitive resin, i.e. a photoresist, so that the organic resin layer can be patterned using a photolithographic technique. In step S170, the second inorganic insulating film ILD2 is formed on top of the plurality of first electrodes E1 and the second organic insulating film PLN2.

### Example

Manufacture of a first substrate CB1 according to an example of Embodiment 2 is described below with reference to FIGS. 4 and 6.

Steps S110 to S160 of FIG. 6 were executed in a manner similar to those of the example of Embodiment 1. Then, the second organic insulating film PLN2 was formed by applying and solidifying a liquid containing a photoresist onto the first organic insulating film PLN1 and performing patterning with a 2-μm photolithographic technique (step S190). Then, steps S170 to S180 were executed in a manner similar to those of the example of Embodiment 1.

### EMBODIMENT 3

### Configuration

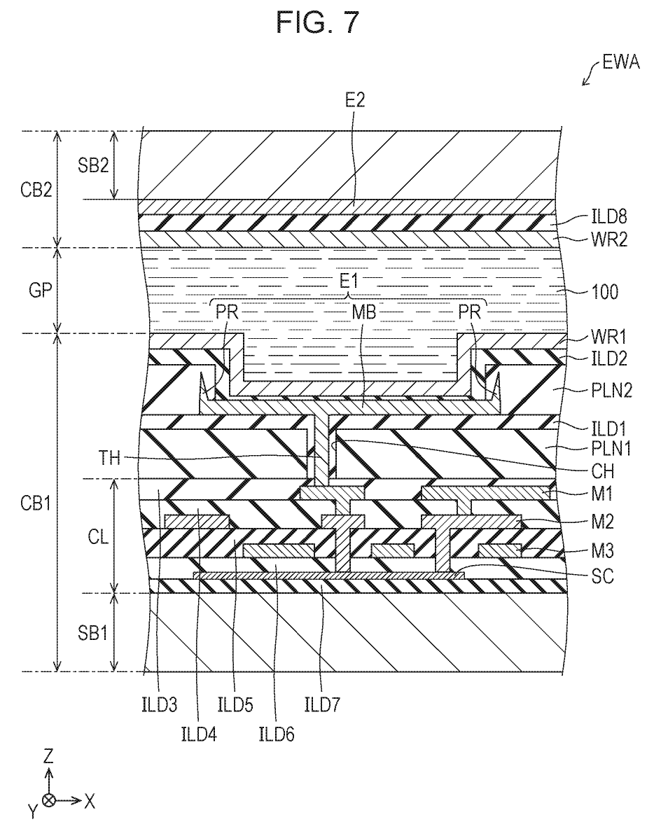

FIG. 7 is a partial cross-sectional view showing an example configuration of an electrowetting apparatus EWA according to an embodiment of the present disclosure. As shown in FIG. 7, the first substrate CB1 of the electrowetting apparatus EWA according to the present disclosure may include a second organic insulating film PLN2 covering an end face of at least one of the plurality of first electrodes E1. The second organic insulating film PLN2 makes it hard for the corresponding first electrode E1 to be touched or collided with by another object (e.g. a hand or an instrument during assembly) and reduces damage of the corresponding first electrode E1 by contact or collision. Coverage of the end face of the corresponding first electrode E1 by the second organic insulating film PLN2 makes it possible to relax the concentration of electric charges on the end face of the first electrode E1 and reduce the occurrence of electrostatic discharge (ESD) from the end face. The coverage further makes it possible to reduce corrosion of the first electrode E1 by the liquid 100 along the end face and a lower surface of the first electrode E1. The "lower surface" is a surface of the first substrate CB1 that faces toward the support SB1.

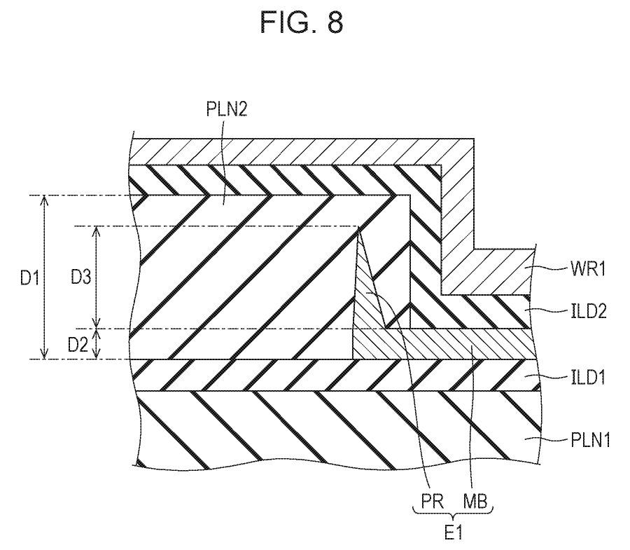

FIG. 8 is a partially enlarged cross-sectional view showing an example configuration of an end portion of a first electrode E1 shown in FIG. 7 and an area therearound. When, as shown in FIG. 8, the first electrode E1 has a body portion MB formed along the first organic insulating film PLN1 and a projecting portion PR, formed on top of an end portion of the body portion MB, that projects from the body portion MB in a direction away from the first organic insulating film PLN1, it is preferable that the second organic insulating film PLN2 cover the projecting portion PR of the corresponding first electrode E1. The coverage of the projecting portion PR of the first electrode E1 by the second organic insulating film PLN2 makes it possible to reduce ESD from the projecting portion PR. The coverage further makes it possible to reduce damage of the projecting portion PR.

### Manufacturing Method

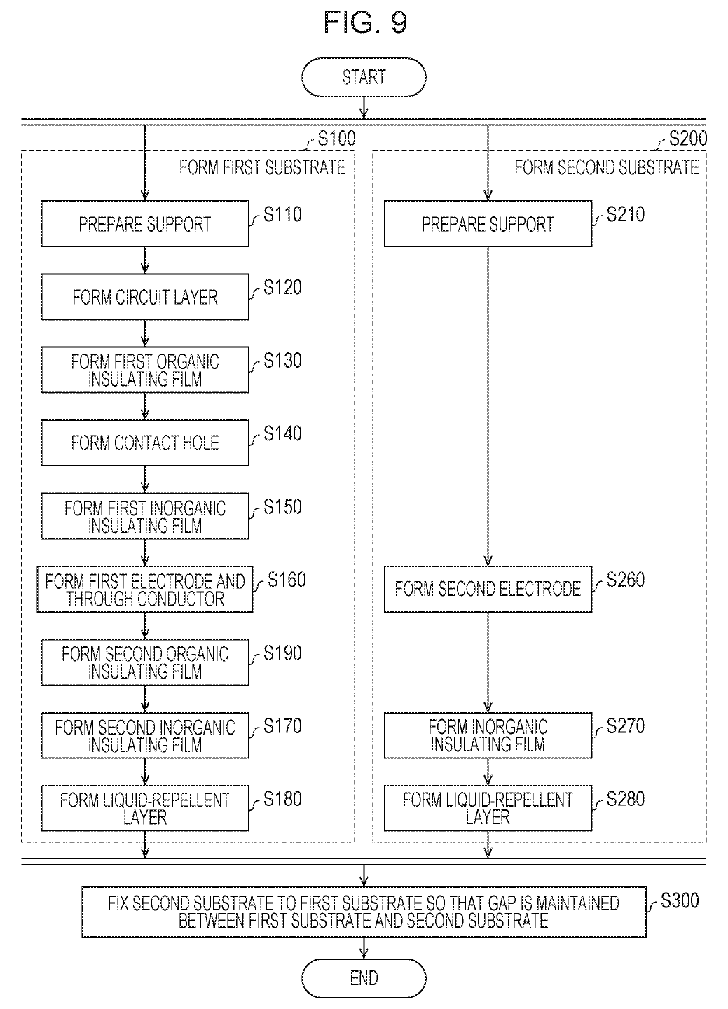

FIG. 9 is a flow chart showing an example of a method for manufacturing the electrowetting apparatus EWA shown in FIG. 7. As shown in FIG. 9, in the formation of the first substrate CB1 (step S100), the second organic insulating film PLN2 is formed (step S190) between the formation of the first electrodes E1 and the through conductors TH (step S160) and the formation of the second inorganic insulating film ILD2 (step S170).

### EMBODIMENT 4

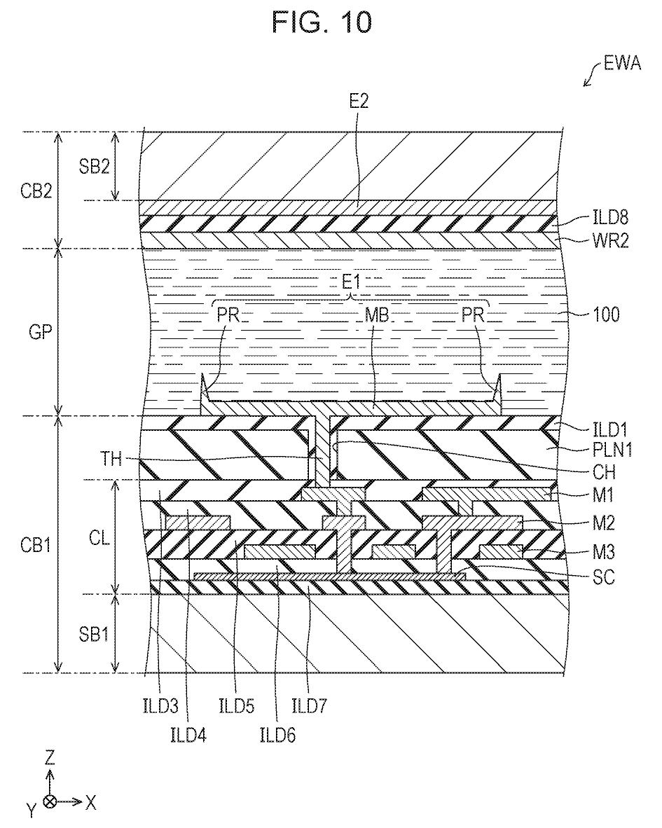

FIG. 10 is a partial cross-sectional view showing an example configuration of an electrowetting apparatus EWA according to an embodiment of the present disclosure. As mentioned above, the plurality of first electrodes E1 are formed from the noble metal, and it is hard for the noble metal to be corroded by the liquid 100. Therefore, the electrowetting apparatus EWA may be configured such that one or more of the plurality of first electrodes E1 come into direct contact with the liquid 100. Specifically, as shown in FIG. 10, in the first substrate CB1 of the electrowetting apparatus EWA according to the present disclosure, at least one of the plurality of first electrodes E1 may be exposed to inside of the gap GP. According to the configuration, since the first electrodes E1 are formed from the noble metal, no passive layer is formed on surfaces of the first electrodes E1, so that metallic portions of the first electrodes E1 can be kept in direct contact with the liquid 100.

The configuration according to the present embodiment can be combined with the configurations according to Embodiments 2 and 3 (FIGS. 4 and 7). A configuration in which the second inorganic insulating film ILD2 and the liquid-repellent layer WR1 are removed from the first substrate CB1 according to Embodiments 2 and 3 is encompassed in the scope of the present disclosure.

### CONCLUSION

An apparatus according to Aspect 1 of the present disclosure is an apparatus for applying a voltage to a liquid. The apparatus includes a first substrate including a support, a plurality of first electrodes formed from a noble metal, and a first organic insulating film located between the support and the plurality of first electrodes and a second substrate including a second electrode facing the plurality of first electrodes. A gap filled with or able to be filled with the liquid is maintained between the first substrate and the second substrate.

According to the foregoing configuration, the plurality of first electrodes are formed from the noble metal, and it is hard for the noble metal to be corroded by the liquid. This makes it possible to improve the durability and reliability of the apparatus.

An apparatus according to Aspect 2 of the present disclosure may be directed to the apparatus according to Aspect 1, wherein the first substrate includes a second organic insulating film located lateral to at least one of the plurality of first electrodes in a cross-sectional view.

According to the foregoing configuration, the second organic insulating film makes it hard for the corresponding first electrode to be touched or collided with by another object and reduces damage of the corresponding first electrode.

An apparatus according to Aspect 3 of the present disclosure may be directed to the apparatus according to Aspect 2, wherein the second organic insulating film surrounds the first electrode in a plan view.

According to the foregoing configuration, the second organic insulating film makes it hard for the corresponding first electrode to be touched or collided with by another object from any direction orthogonal to the Z axis and further reduces damage of the corresponding first electrode.

An apparatus according to Aspect 4 of the present disclosure may be directed to the apparatus according to Aspect 2 or 3, wherein the first electrode has a body portion formed along the first organic insulating film and a projecting portion, formed on top of an end portion of the body portion, that projects from the body portion in a direction away from the first organic insulating film, and a thickness of the second organic insulating film is greater than or equal to a sum of a thickness of the body portion and a height of the projecting portion.

According to the foregoing configuration, the second organic insulating film makes it hard for the corresponding first electrode to be touched or collided with by another object at any level in a Z-axis direction and further reduces damage of the corresponding first electrode.

An apparatus according to Aspect 5 of the present disclosure may be directed to the apparatus according to Aspect 1, wherein the first substrate includes a second organic insulating film covering an end face of at least one of the plurality of first electrodes.

According to the foregoing configuration, the second organic insulating film can reduce damage of the corresponding first electrode and reduce the occurrence of electrostatic discharge (ESD) from an end face of the corresponding first electrode, making it possible to reduce corrosion of the corresponding first electrode by the liquid.

An apparatus according to Aspect 6 of the present disclosure may be directed to the apparatus according to Aspect 5, the first electrode has a body portion formed along the first organic insulating film and a projecting portion, formed on top of an end portion of the body portion, that projects from the body portion in a direction away from the first organic insulating film, and the second organic insulating film covers the projecting portion.

According to the foregoing configuration, the second organic insulating film can reduce damage of the projecting portion of the corresponding first electrode and reduce the occurrence of electrostatic discharge (ESD) from the projecting portion of the corresponding first electrode.

An apparatus according to Aspect 7 of the present disclosure may be directed to the apparatus according to any one of Aspects 1 to 6, wherein the first substrate includes a first inorganic insulating film located between the first organic insulating film and the plurality of first electrodes.

The foregoing configuration makes it hard for the first organic insulating film to swell, and makes it harder for the liquid to penetrate toward the support beyond the first organic insulating film. This makes it possible to further improve the durability and reliability of the apparatus.

An apparatus according to Aspect 8 of the present disclosure may be directed to the apparatus according to any one of Aspects 1 to 7, wherein the first substrate includes a liquid-repellent layer, located opposite the support behind the plurality of first electrodes, that repels the liquid and a second inorganic insulating film located between the plurality of first electrodes and the liquid-repellent layer.

The foregoing configuration makes it hard for the first organic insulating film to swell, and makes it harder for the liquid to penetrate toward the support beyond the first organic insulating film. This makes it possible to further improve the durability and reliability of the apparatus.

An apparatus according to Aspect 9 of the present disclosure may be directed to the apparatus according to any one of Aspects 1 to 7, wherein one or more of the plurality of first electrodes are exposed to inside of the gap.

According to the foregoing configuration, one or more of the plurality of first electrodes can come into direct contact with the liquid. Since the first electrodes are formed from the noble metal, no passive layer is formed on surfaces of the first electrodes, so that metallic portions of the first electrodes can be kept in direct contact with the liquid.

An apparatus according to Aspect 10 of the present disclosure may be directed to the apparatus according to any one of Aspects 1 to 9, wherein the first substrate further includes a wire, located between the support and the first organic insulating film, that contains a metal that is corroded by the liquid.

According to the foregoing configuration, the wire contains a metal that is corroded by the liquid. The metal that is corroded by the liquid can be subjected to wet etching and/or dry etching and is easily processed into a desired shape. Therefore, it is easy to form a wire that contains the metal that is corroded by the liquid.

A manufacturing method according to Aspect 11 of the present disclosure in a method for manufacturing the apparatus according to any one of Aspects 1 to 10. The method includes forming a photoresist layer on top of the first organic insulating film, patterning the photoresist layer so that an end portion of the photoresist layer has an inverse tapered shape, forming a noble metal layer on top of the photoresist layer thus patterned and on top of a portion of the first organic insulating layer exposed from the photoresist layer, and forming the plurality of first electrodes from the noble metal layer by removing the photoresist layer together with a portion of the noble metal layer formed on top of the photoresist layer.

According to the foregoing method, the plurality of first electrodes can be formed from one noble metal layer. This makes it possible to manufacture the apparatus according to the present disclosure.

The present disclosure is not limited to the embodiments described above. but may be variously altered within the scope of the claims, and an embodiment based on a proper combination of technical means disclosed in different embodiments is encompassed in the technical scope of the present disclosure. Furthermore, a new technical feature can be formed by a combination of technical means disclosed separately in each of the embodiments.

The present disclosure contains subject matter related to that disclosed in Japanese Priority Patent Application JP 2025-048787 filed in the Japan Patent Office on Mar. 24, 2025, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An apparatus for applying a voltage to a liquid, the apparatus comprising:
a first substrate including a support, a plurality of first electrodes formed from a noble metal, and a first organic insulating film located between the support and the plurality of first electrodes; and
a second substrate including a second electrode facing the plurality of first electrodes,
wherein a gap filled with or able to be filled with the liquid is maintained between the first substrate and the second substrate.

2. The apparatus according to claim 1, wherein the first substrate includes a second organic insulating film located lateral to at least one of the plurality of first electrodes in a cross-sectional view.

3. The apparatus according to claim 2, wherein the second organic insulating film surrounds the first electrode in a plan view.

4. The apparatus according to claim 2, wherein
the first electrode has a body portion formed along the first organic insulating film and a projecting portion, formed on top of an end portion of the body portion, that projects from the body portion in a direction away from the first organic insulating film, and
a thickness of the second organic insulating film is greater than or equal to a sum of a thickness of the body portion and a height of the projecting portion.

5. The apparatus according to claim 1, wherein the first substrate includes a second organic insulating film covering an end face of at least one of the plurality of first electrodes.

6. The apparatus according to claim 5, wherein
the first electrode has a body portion formed along the first organic insulating film and a projecting portion, formed on top of an end portion of the body portion, that projects from the body portion in a direction away from the first organic insulating film, and
the second organic insulating film covers the projecting portion.

7. The apparatus according to claim 1, wherein the first substrate includes a first inorganic insulating film located between the first organic insulating film and the plurality of first electrodes.

8. The apparatus according to claim 1, wherein the first substrate includes
a liquid-repellent layer, located opposite the support behind the plurality of first electrodes, that repels the liquid, and
a second inorganic insulating film located between the plurality of first electrodes and the liquid-repellent layer.

9. The apparatus according to claim 1, wherein one or more of the plurality of first electrodes are exposed to inside of the gap.

10. The apparatus according to claim 1, wherein the first substrate further includes a wire, located between the support and the first organic insulating film, that contains a metal that is corroded by the liquid.

11. A method for manufacturing the apparatus according to claim 1, the method comprising:
forming a photoresist layer on top of the first organic insulating film;
patterning the photoresist layer so that an end portion of the photoresist layer has an inverse tapered shape;
forming a noble metal layer on top of the photoresist layer thus patterned and on top of a portion of the first organic insulating layer exposed from the photoresist layer; and
forming the plurality of first electrodes from the noble metal layer by removing the photoresist layer together with a portion of the noble metal layer formed on top of the photoresist layer.
